(19) United States
(12) Patent Application Publication
(10) Pub. No.: US 2013/0159927 A1
(43) Pub. Date: Jun. 20, 2013

(54) ELECTRONIC DEVICE WITH TOUCH SCREEN AND SCREEN UNLOCKING METHOD THEREOF

(71) Applicants: CHIA-HAO CHUANG, Tu-Cheng (TW); CHIH-SAN CHIANG, Tu-Cheng (TW); SHENG-CHU LU, Shenzhen City (CN); XUE-TAO TAN, Shenzhen City (CN); DA-JUN XIONG, Shenzhen City (CN); YUAN-YUAN JIANG, Shenzhen City (CN)

(72) Inventors: CHIA-HAO CHUANG, Tu-Cheng (TW); CHIH-SAN CHIANG, Tu-Cheng (TW); SHENG-CHU LU, Shenzhen City (CN); XUE-TAO TAN, Shenzhen City (CN); DA-JUN XIONG, Shenzhen City (CN); YUAN-YUAN JIANG, Shenzhen City (CN)

(21) Appl. No.: 13/666,874

(22) Filed: Nov. 1, 2012

(30) Foreign Application Priority Data
Dec. 17, 2011 (CN) 201110423695.0

(51) Int. Cl. G06F 3/041; G06F 3/048

(52) U.S. Cl. 715/810; 715/764

(57) ABSTRACT

An exemplary provided screen unlocking method for an electronic device with a touch screen comprises the following steps: displaying a screen unlocking interface on the touch screen; generating unlocking signals in response to an unlocking operation applied on the touch screen; determining whether the enduring touch time period of the unlocking operation reaches a predetermined touch time period, and whether the touch area of the unlocking operation reaches a predetermined touch area, according to the unlocking signals; and unlocking the touch screen when the enduring touch time period of the unlocking operation reaches the predetermined touch time period, and the touch area of the unlocking operation reaches the predetermined touch area. An electronic device using the screen unlocking method is also provided.

### BACKGROUND

1. Technical Field

The present disclosure relates to an electronic device and a screen unlocking method thereof.

2. Description of Related Art

Electronic devices with touch screens, mobile phones, digital photo frames, electronic readers (e-reader), for example, are popular. To aviod operating the touch screen unintentionly, the touch screen is locked when not in use, and an unlocking procedure such as entering a code or password is needed for unlocking the touch screen. However, the conventional unlocking methods have drawbacks. For example, the unlocking password is difficult to memorize, the unchangeable unlocking method is tedious and boring, which cannot satisfy the demands of various users.

Therefore, what is needed is an electronic device and a screen unlocking method thereof to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device in accordance with an exemplary embodiment.

FIG. 2 is a flowchart of a screen unlocking method for electronic devices, such as the one of FIG. 1, in accordance with the exemplary embodiments.

FIGS. 3-5 are schematic diagrams showing the unlocking interfaces displayed on the touch screen of the electronic device of FIG. 1, in accordance with the exemplary embodiments.

### DETAILED DESCRIPTION

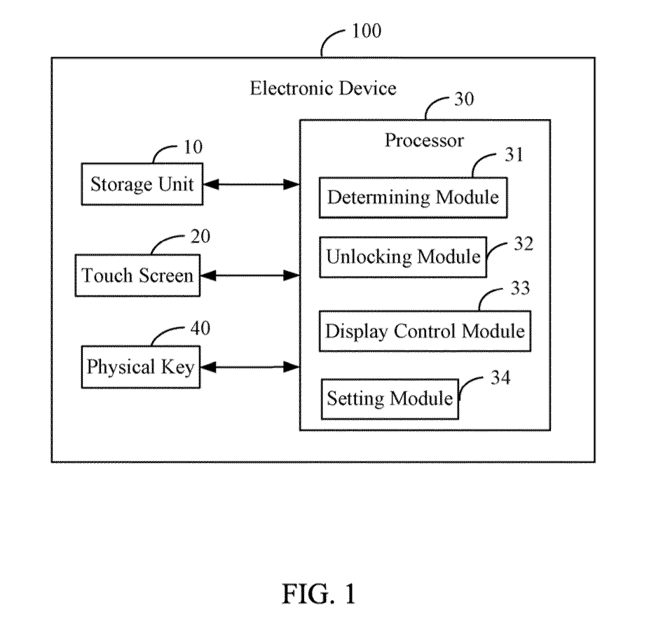

FIG. 1 is an exemplary embodiment of a block diagram of an electronic device 100. The electronic device 100 can conveniently unlock the screen as long as the enduring time period of an unlocking touch operation applied on the touch screen of the electronic device 100 reaches a predetermined touch time period and the touch area reaches a predetermined touch area. The electronic device 100 is a mobile terminal with a touch screen, such as a mobile phone. In alternative embodiments, the electronic device 100 can be other electronic devices with touch screens, such as an electronic reader, a tablet, a digital phone frame, for example.

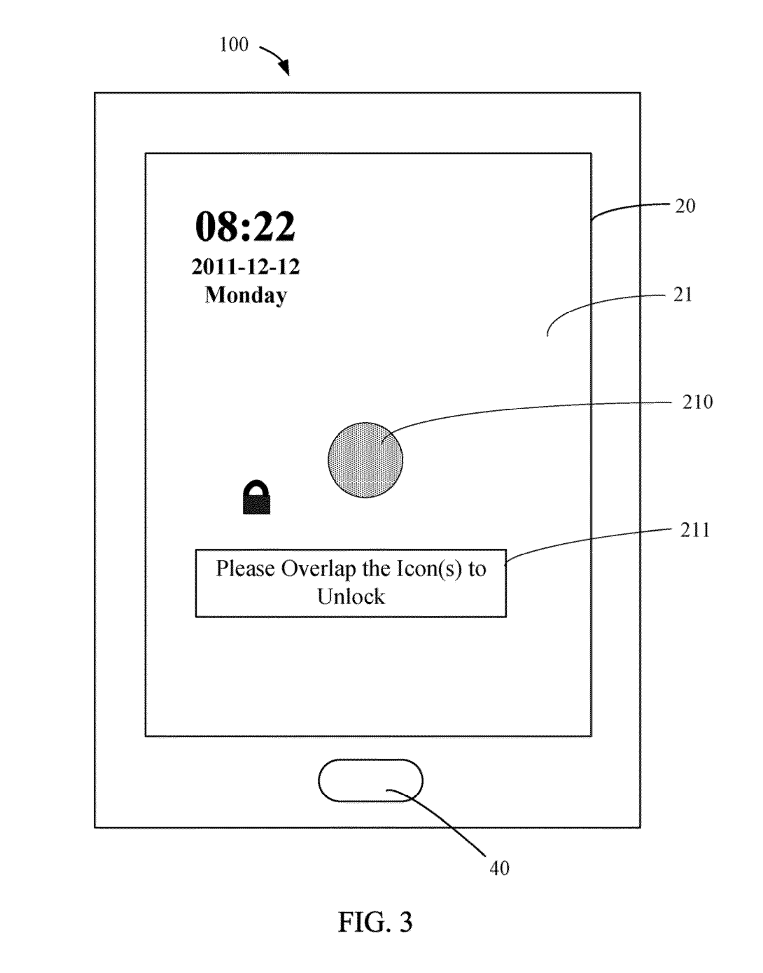

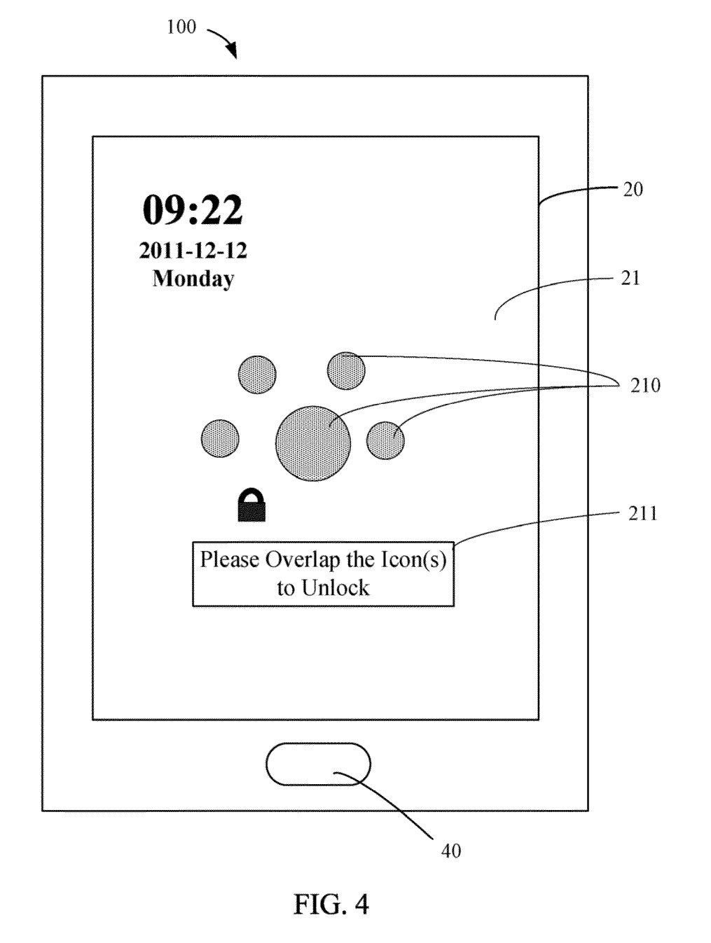

The electronic device 100 includes a storage unit 10, a touch screen 20, a processor 30, and a physical key 40. The processor 30 includes a determining module 31, an unlocking module 32, a display control module 33, and a setting module 34. When the physical key 40 is depressed, a trigger signal for activating the unlocking process is generated and is transmitted to the processor 30. The processor 30 wakes up or locks the electronic device 100 according to the trigger signal. The display control module 33 controls the touch screen 20 to display an unlocking interface. In an embodiment, for example, referring to FIGS. 3 and 4, the unlocking interface 21 includes at least one unlocking icon 210 and an unlocking prompt box 211. The unlocking prompt box 211 is configured for prompting the user to overlap one or more unlocking icon(s) 210 displayed on the unlocking interface 21 to unlock the touch screen 20. The number of the unlocking icon 210 can be predetermined according to actual need. The shape of the unlocking icon 210 can also be predetermined according to actual need. The unlocking interface 21 may also not include the unlocking prompt box 211.

The setting module 34 is configured for generating setting signals in response to setting touch operations applied on the touch screen 20. For example, the setting touch operations for setting the number of unlocking regions, the touch time period, and/or the touch area for unlocking the touch screen 20.

The storage unit 10 stores a predetermined touch time period and a predetermined touch area. The predetermined touch time period and the predetermined touch area are predefined by the user or default of the system of the electronic device 100, for unlocking the touch screen 20. When being locked, the touch screen 20 can generate unlocking signals in response to the unlocking operation. The determining module 31 is configured for determining whether the enduring touch time period of the unlocking operation applied on the touch screen 20 reaches the predetermined touch time period, and whether the touch area of the unlocking operation reaches the predetermined touch area, according to the unlocking signals generated by the touch screen 20.

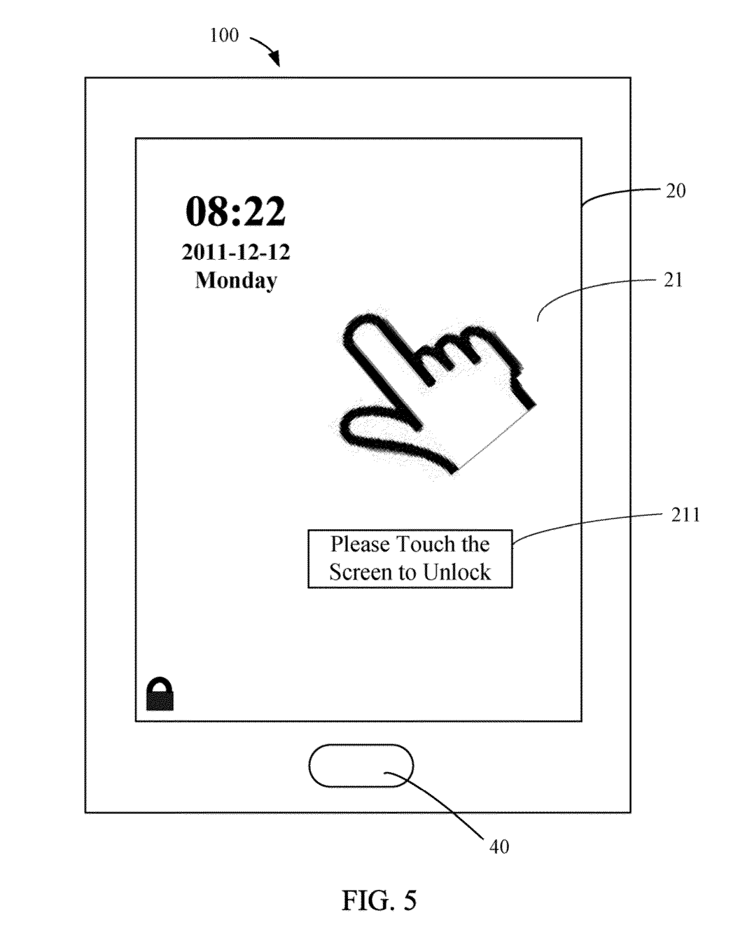

In a first embodiment, the touch area is the total touch area of the touch operation synchronously applied on the touch screen 20. For example, when the unlocking interface displayed on the touch screen 20 is shown as FIG. 5 shows. The user can use a single finger, two fingers, or more fingers to touch any position of the touch screen 20 for unlocking the touch screen 20. As long as the determining module 31 determines the total touch area of the finger(s) reaches the predetermined touch area, and the touch time period reaches the predetermined touch time period, the unlocking module 32 unlocks the touch screen 20.

In a second embodiment, the storage unit 10 also stores coordinate(s) of one or more predefined unlocking region. For example, when the unlocking interface displayed on the touch screen 20 is shown as FIG. 3 or FIG. 4 shows. If the determining module 31 determines the unlocking operation is applied within the predetermined unlocking region, that is, the coordinates of the unlocking operation applied on the touch screen 20 overlap with the coordinates of the predefined unlocking region. If the touch area reaches the predefined touch area as well, and the touch time period reaches the predefined touch time period, then, the unlocking module unlocks the touch screen 20.

In a third embodiment, the number of predefined unlocking region stored in storage unit 10 is less than the number of the unlocking icons 210 displayed on the touch screen 20, and each of the unlocking region associated with one of the unlocking icons 210. An unlocking region associated with an unlocking icon 210 means the unlocking icon 210 overlaps the unlocking region. For example, presuming the number of the predefined unlocking region is three, the predetermined touch time period is two seconds, and the predetermined touch area is three square centimeters, the unlocking interface displayed on the touch screen 20 is shown as FIG. 4, that is, five unlocking icons 210 are displayed thereon. Then, if the determining module 31 determines three of the five unlocking icons 210 are touched by the user at the same time. The user uses three fingers touching three unlocking icons 210 respectively, for example, If the determining module 31 determines the enduring touch time period of the unlocking operation on the three unlocking icons 210 reaches two seconds, as well, and the total touch area of the unlocking operation on the three unlocking icons 210 reaches three square centimeters. The unlocking module 32 unlocks the touch screen 20.

In a fourth embodiment, each of the unlocking regions is not associated with a particular unlocking icon. That is, no unlocking icon is displayed such as shown in FIG. 5, if the determining module 31 determines the user touches three regions of the touch screen 20, the enduring touch time period reaches two seconds, and the total touch area reaches three square centimeters. Then the unlocking module 32 unlocks the touch screen 20.

In a fifth embodiment, the storage unit 10 stores a predetermined range of the touch time period and a predetermined range of the touch area predefined by the user or defaults of the system of the electronic device 100, for unlocking the touch screen 20. For example, the predetermined range of the touch time period can be 2-3 seconds, and the predetermined range of the touch area can be 2-3 square centimeters. When the enduring touch time period of an unlocking operation falls in the predetermined range of the touch time period, and the touch area of the unlocking operation falls in the predetermined range of the touch area, the touch screen 20 will be unlocked.

The display control module 33 is configured for controlling the touch screen 20 to display a user interface after the touch screen 20 is unlocked by the unlocking module 32. In an embodiment, the display control module 33 also controls the touch screen 20 to display a prompt box for prompting the user that the unlocking process fails, when the unlocking module 32 does not unlock the touch screen 20 because of a false unlocking operation.

As such, in one embodiment, when the touch screen 20 is locked, the determining module 31 determines one or more finger(s) touches the region(s) of the unlocking icon(s) or any position of the touch screen 20. If the enduring touch time period reaches the predetermined touch time period, and the touch area reaches the predetermined touch area, the unlocking module 32 unlocks the touch screen 20. In another embodiment, when the determining module 31 determines the number of the unlocking icon(s) touched by the user is equal to the predetermined number of the unlocking icon(s), the unlocking module 32 unlocks the touch screen 20. In an alternative embodiment, when the touch screen 20 is locked, and the determining module 31 determines the enduring touch time period of an unlocking operation falls in the predetermined range of the touch time period, and the touch area of the unlocking operation falls in the predetermined range of the touch area, the unlocking module 32 unlocks the touch screen 20.

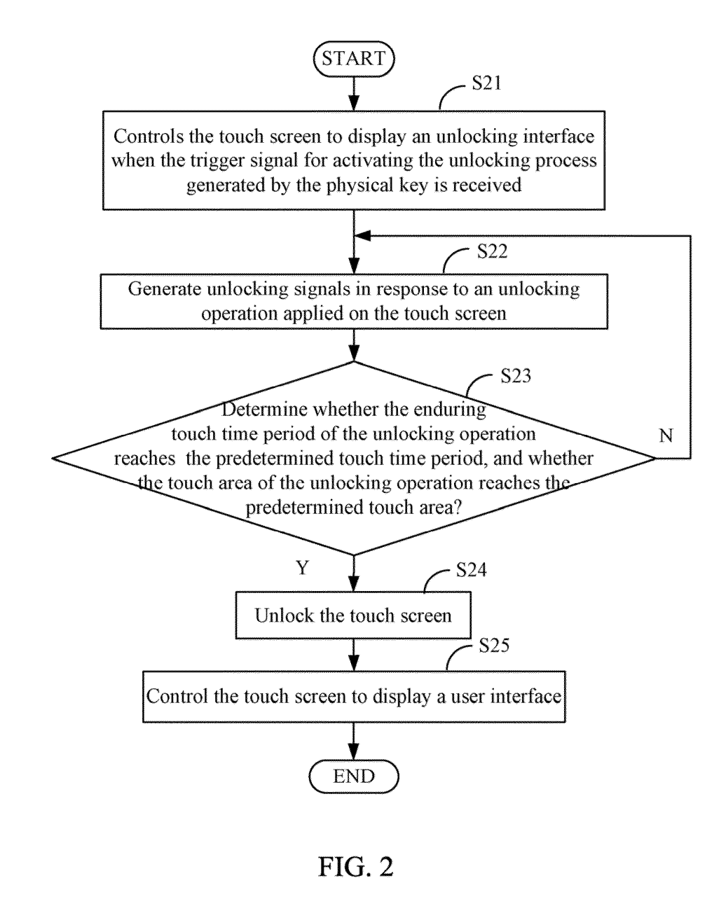

FIG. 2 shows a flowchart of a screen unlocking method of the electronic device 100 of FIG. 1. The electronic device 100 includes a touch screen, a physical key and a storage unit. The touch screen is configured for generating operation signals in response to the operations of a user. The physical key is configured for generating a trigger signal when being depressed. The storage unit stores a predetermined touch time period and a predetermined touch area for unlocking the touch screen 20. The touch area is the total touch area of the touch operation synchronously applied on the touch screen 20. In another embodiment, the storage unit also stores coordinate(s) of one or more predefined unlocking regions. In another embodiment, the number of the predefined unlocking regions stored in storage unit 10 is less than the number of the unlocking icons displayed on the touch screen, and each of the unlocking regions is associated with one of the unlocking icons. In an alternative embodiment, the storage unit stores a predetermined range of the touch time period and a predetermined range of the touch area. The method includes the following steps, each of which is related to the various components contained in the electronic device 100.

In step S21, the display control module 33 controls the touch screen 20 to display an unlocking interface when the trigger signal for activating the unlocking process generated by the physical key 40 is received. One or more unlocking icon(s) and an unlocking prompt box are displayed on the unlocking interface. In an alternative embodiment, the unlocking interface does not include the unlocking prompt box.

In step S22, the touch screen 20 generates unlocking signals in response to an unlocking operation applied on the touch screen 20.

In step S23, the determining module 31 determines whether the enduring touch time period of the unlocking operation reaches the predetermined touch time period, and whether the touch area of the unlocking operation reaches the predetermined touch area, according to the unlocking signals. If both yes, the process goes to step S24, otherwise, the unlocking module 32 continues to keep locking the touch screen 20, the process goes back to the step S22. In an embodiment, the determining module 31 also determines whether the unlocking operation is applied within the predetermined unlocking region. When the unlocking operation is applied within the predetermined unlocking region, the enduring touch time period of the unlocking operation reaches the predetermined touch time period. In addition, the touch area of the unlocking operation reaches the predetermined touch area, the process goes to step S24, otherwise, as long as one of the conditions is not satisfied, the unlocking module 32 continues to keep the touch screen 20 locked, the process goes back to the step S22. In an alternative embodiment, the determining module 31 determines whether the endured touch time period of an unlocking operation falls in the predetermined range of the touch time period. Whether the touch area of the unlocking operation falls in the predetermined range of the touch area, if both yes, the process goes to step S24, otherwise, the unlocking module 32 continues to keep the touch screen 20 locked, the process goes back to the step S22.

In step S24, the unlocking module 32 unlocks the touch screen 20.

In step S25, the display control module 33 controls the touch screen 20 to display a user interface.

With such a configuration, when the unlocking interface is displayed on the touch screen 20 in response to the operation of the user, the touch screen 20 can easily be unlock by touching the unlocking icons displayed on the unlocking interface or touching any position of the touch screen 20 for a predetermined time period and a predetermined area.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A screen unlocking method for an electronic device with a touch screen, the method comprising:
displaying a screen unlocking interface on the touch screen;
generating unlocking signals in response to an unlocking operation applied on the touch screen;
determining whether a touch time period of the unlocking operation reaches a predetermined time period, and whether the touch area of the unlocking operation reaches a predetermined area, according to the unlocking signals; and
unlocking the touch screen if the touch time period of the unlocking operation reaches the predetermined time period, and the touch area of the unlocking operation reaches the predetermined area.

2. The method as described in claim 1, wherein the unlocking operation is applied on any position of the touch screen.

3. The method as described in claim 1, wherein the unlocking operation is applied within a predetermined unlocking region.

4. The method as described in claim 1, wherein before the step of “displaying an unlocking interface on the touch screen”, the method further comprises: generating an unlocking trigger signal in response to a user's operation.

5. The method as described in claim 1, further comprising: displaying a user interface on the touch screen after the touch screen is unlocked.

6. An unlocking method for an electronic device with a touch screen, the method comprising:
generating an unlocking trigger signal in response to a user's operation;
displaying a screen unlocking interface on the touch screen;
generating unlocking signals in response to an unlocking operation applied on the touch screen;
determining whether a touch time period of the unlocking operation falls in a predetermined range of touch time period, and whether the touch area of the unlocking operation falls in a predetermined range of touch area; and
unlocking the touch screen if the touch time period of the unlocking operation falls in the predetermined range of touch time period, and the touch area of the unlocking operation falls in the predetermined range of the touch area.

7. The method as described in claim 6, wherein the unlocking operation is applied on any position of the touch screen.

8. The method as described in claim 6, wherein the unlocking operation is applied within a predetermined unlocking region.

9. The method as described in claim 6, further comprising: displaying a user interface on the touch screen after the touch screen is unlocked.

10. An electronic device, comprising:
a storage unit;
a touch screen, configured for generating unlocking signals in response to an unlocking operation applied thereon; and
a processor comprising:
a display control module, configured for displaying a screen unlocking interface on the touch screen;
a determining module, configured for determining whether a touch time period of the unlocking operation reaches a predetermined touch time period, and whether a touch area of the unlocking operation reaches a predetermined touch area, according to the unlocking signals; and
an unlocking module, configured for unlocking the touch screen if the touch time period of the unlocking operation reaches the predetermined touch time period, and the touch area of the unlocking operation reaches the predetermined touch area.

11. The electronic device as described in claim 10, further comprising a physical key for generating an unlocking trigger signal in response to a user's operation.

12. The electronic device as described in claim 10, further comprising a setting module, configured for generating setting signals for unlocking the touch screen in response to setting touch operations applied on the touch screen, wherein the setting touch operation is selected from the group consisting of: setting the number of unlocking regions, setting the touch time period, and setting the touch area.

13. The electronic device as described in claim 10, wherein the storage unit stores a predetermined touch time period and a predetermined touch area for unlocking the touch screen.

14. The electronic device as described in claim 13, wherein the storage unit also stores coordinates of one or more predefined unlocking region.

15. The electronic device as described in claim 14, wherein the quantity of the predefined unlocking region is also stored in storage unit, the unlocking interface comprises at least one unlock icon, and each of the unlocking region is associated with one corresponding unlocking icon.

16. The electronic device as described in claim 10, wherein the determining module is further configured for determining whether the touch time period of the unlocking operation falls in a predetermined range of touch time period, and whether the touch area of the unlocking operation falls in a predetermined range of touch area; and the unlocking module is further configured for unlocking the touch screen if the touch time period of the unlocking operation falls in the predetermined range of touch time period, and the touch area of the unlocking operation falls in the predetermined range of touch area.

17. The electronic device as described in claim 16, wherein the storage unit stores the predetermined range of touch time period and the predetermined range of the touch area.

18. The electronic device as described in claim 10, wherein the unlocking operation is applied on any position of the touch screen.

19. The electronic device as described in claim 10, wherein the unlocking operation is applied within a predetermined unlocking region.

20. The electronic device as described in claim 10, wherein the display control module further controls the touch screen to display a user interface after the touch screen is unlocked.
